(19) United States
(12) Patent Application Publication
(10) Pub. No.: US 2003/0116075 A1
(43) Pub. Date: Jun. 26, 2003

(54) Trailer hookup aid and method

(76) Inventor: Jules A. Darras, Temecula, CA (US)

Correspondence Address: LAW OFFICES OF GEORGE J. NETTER, 260 SOUTH LOS ROBLES, SUITE 216, PASADENA, CA, 91101, US

(21) Appl. No.: 10/025,956

(22) Filed: Dec. 26, 2001

(51) Int. Cl. G01C 1/00

(52) U.S. Cl. 116/28 R; 33/264

(57) ABSTRACT

For aiding in the interconnection of a trailer (10) of the so-called fifth wheel variety to complementary hitching apparatus (22) mounted to the bed of a towing vehicle (14), an alignment target (24) is removably positioned on the vehicle bed along the bed longitudinal axis via which the vehicle driver effects interconnection with maximum driving efficiency and minimal backing attempts.

### BACKGROUND

1. Background of the Invention

The present invention relates generally to effecting interconnection of a trailer, and, more particularly, to means and method for aiding in the initial positioning of the hitch of a so-called fifth wheel trailer to a towing vehicle facilitating final interconnection.

2. Description of Related Art

A popular manner of interconnecting a large trailer to a towing vehicle is referred to as a “fifth wheel” system. In a typical fifth wheel arrangement, a towing truck with a flat bed is backed toward the trailer until hitch apparatus securely fixed to the truck bed engages hitch apparatus of the trailer, and interconnection is made for towing. In the past, this process has been accomplished in a manner depending more on the experience and skill of the driver than may be comfortable to a beginning or less skilled driver on attempting to maneuver and interconnect two relatively large and heavy pieces of equipment. If incorrectly attempted, damage may be done to the tow vehicle hitch, trailer hitch apparatus, or to the vehicle or trailer per se. Frequently, another individual standing nearby the truck is used to advise the driver as to the connection progress. When proceeding in this manner, it is not unusual to have several failed attempts at lateral positioning, requiring the truck to move forward and backward several times in order to adjust the truck position along a supposed alignment path for final interconnection. The difficulty is often increased by the towing vehicle having obstructions to rearward viewing, such as, for example, a tool box mounted in the vehicle truck bed behind the cab obscuring view through the rear window of the truck hitch apparatus. As another example, the trailer may be parked where there is restricted space for maneuvering. Finally, when lateral alignment has been hopefully achieved, the proper vertical alignment of the truck and trailer hitch apparatus often must be achieved before final interconnection is possible. This has often been done by the driver or a helper “eyeballing” the vertical spacing between the load bearing horizontal surfaces of the truck and trailer hitch apparatus during the process of backing to engagement, adjusting the trailer hitch apparatus up or down to obtain desirably a “0” spacing at connection. When proceeding in this manner, it is not unusual to change the adjustment several times.

### SUMMARY OF THE INVENTION

It is a primary aim and object of the invention to provide means and method for aiding a vehicle driver to view from the vehicle rear window and precisely align trailer hitch apparatus laterally with onboard complementary apparatus by mere driver induced movement of the vehicle.

Another object in accordance with the previous object is the positioning of a highly visible target element on the vehicle truck bed aligned with the complementary vehicle hitch apparatus via which the driver can facilitate lateral alignment movement of the vehicle with the trailer hitch so that the vehicle hitch apparatus is laterally aligned for locking engagement with the trailer hitch apparatus.

Yet another object is the provision of means and method for aiding in the precise vertical alignment of the trailer hitch apparatus with the vehicle complementary apparatus requiring only a single vertical adjustment of the trailer hitch apparatus.

A still further object is the provision of means and method including an accurate height comparison element positioned on the truck bed closely adjacent the complementary hitch apparatus via which the trailer hitch apparatus can be precisely vertically adjusted to mate with complementary hitch apparatus.

### BRIEF DESCRIPTION OF THE DRAWING

These and other objects of the present invention will become more readily apparent upon reading the following detailed description and upon reference to the attached drawings in which:

FIG. 1 is a perspective, partially fragmentary view of a towing vehicle and trailer with fifth wheel hitching means looking generally rearwardly toward the trailer;

FIG. 2 is a perspective, partially fragmentary view of the towing vehicle looking forwardly toward the vehicle cab;

FIG. 3 depicts a trailer fifth-wheel hitch along a lateral alignment line defined by a target means of the invention for precise lateral alignment preparatory to final connection;

FIG. 4 shows the trailer fifth-wheel hitch apparatus in lock-in position immediately above the complementary apparatus on board the towing vehicle preparatory to lowering into full load bearing engagement with the complementary apparatus; and

FIGS. 5A and 5B are schematic representations of the method steps involved in the invention.

### DESCRIPTION OF A PREFERRED EMBODIMENT

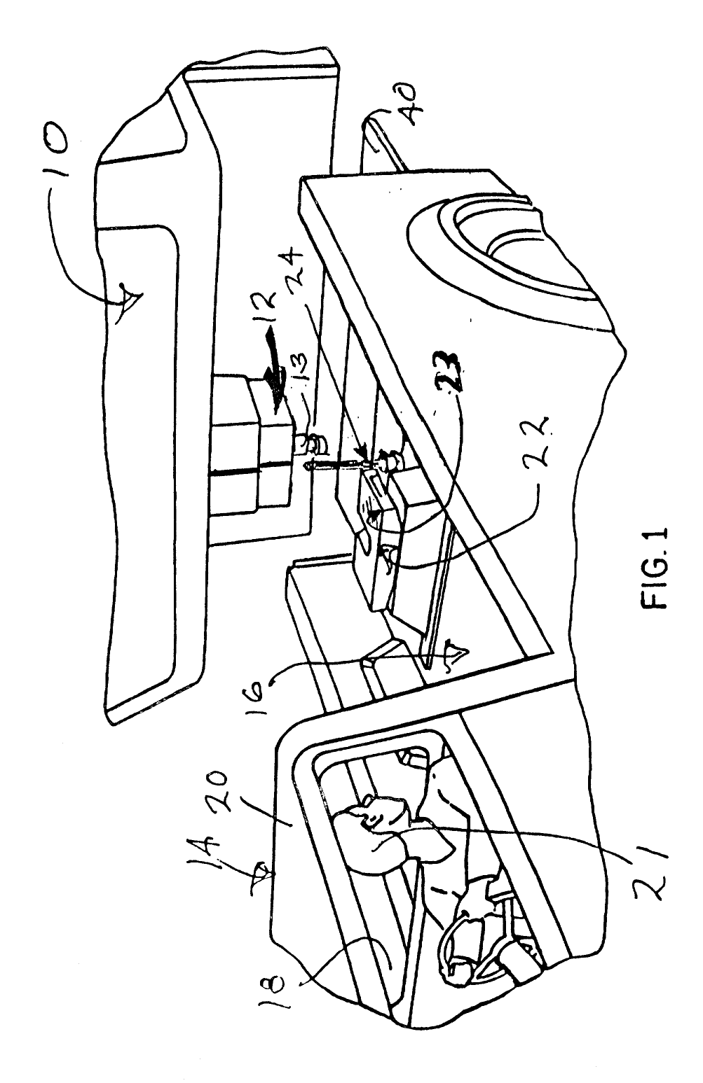

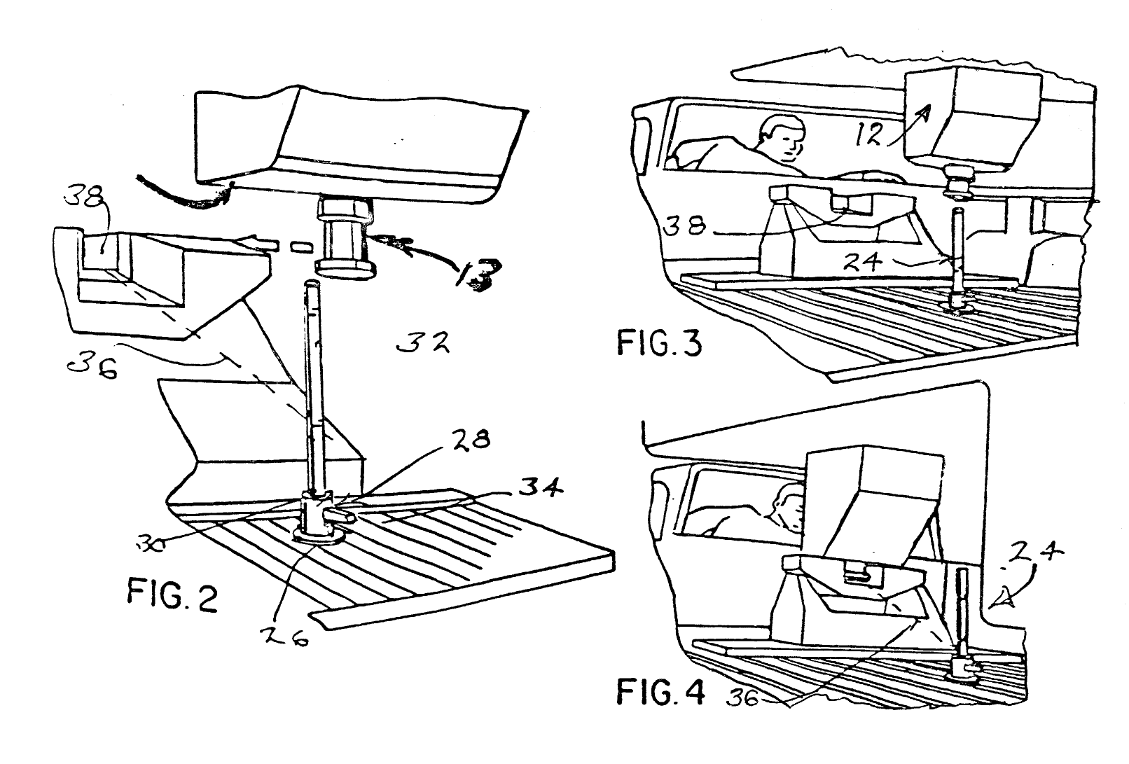

Turning now to the drawing, and particularly FIG. 1, there is shown the front portion of a trailer 10 with a hitch apparatus 12 which is of the variety referred to as a “fifth wheel”. Forwardly of the trailer is a vehicle 14 contemplated for use in transporting the trailer, which typically is a truck having an open flat bed 16 and a rear window 18 on the truck cab 20 via which a driver 21 has a view of the truck bed as well as front part of the trailer. Complementary hitching apparatus 22 is secured to the truck bed and, as will be described in greater detail, cooperates with the hitch apparatus 12 to provide the necessary firm and reliable connection of the trailer to the towing vehicle.

The trailer with which we are primarily concerned here has such bulk and weight that it would be difficult to move it sideways even a slight amount when it is stopped or parked. The trailer hitch apparatus 12 can be moved vertically with respect to the ground plane, however, for positioning apparatus 12 with respect to apparatus 22 for interconnection. Accordingly, it can be assumed that for all practical reasons when other than vertical relative movement between the towing vehicle and the trailer is required, during the procedure to achieve proper alignment of hitching apparatus 12 with the complementary apparatus 22, this movement or adjustment will be provided solely by vehicle movement (i.e., back-and-forth and laterally).

In attempting interconnection of a fifth wheel hitch, a driver 21 backs the vehicle toward the trailer trying to laterally align the trailer hitching apparatus so that continued backing movement will precisely laterally locate the lateral centerline of hitch pin 13 of apparatus 12 closely behind the lateral centerline of apparatus 22. Until now, not infrequently, although a driver has endeavored to align the apparatus, misalignment has resulted instead, and the vehicle has to be pulled forward and another backing attempt made. Unsuccessful attempts have resulted even when another individual standing outside the vehicle was giving fine tuning instructions to the driver. Moreover, since a towing vehicle may have obstructions to rearward viewing by the driver (e.g., toolboxes mounted in the truck bed adjacent the cab window), or the trailer is parked on uneven ground or in an area with restricted approach, any or all of these conditions can make the backing alignment step even more difficult.

In the practice of the present invention, an alignment target 24 is provided having a platelike base 26 onto which is secured generally centrally a support housing 28 with an opening 30 in a top surface thereof. A visible marker 32 is slidingly received within the opening 30 and adjustably extendible therefrom over a predetermined range. Control arm 34 can be adjusted in one direction to allow marker extension adjustment, or in an opposite or other direction to maintain a certain adjustment. The base, housing and marker are so constructed that when the base rests on a horizontal surface (e.g., truck bed) the marker extends perpendicularly upward.

It is preferable that the base 26 be magnetic so that when the target 24 is positioned on the vehicle bed base the magnetic force will securely maintain the target in an upright predetermined location in windy conditions, or even though the vehicle is being shaken somewhat during movement. Moreover, to improve sighting ability of the marker 32, it is preferable the marker be painted distinctly as with white, yellow or a luminescent paint. This latter feature is especially advantageous when practicing the method of the invention during inclement weather or in poor light conditions, such as late in the evening. For the same reasons, pin 13 may be similarly painted.

As a first step in the practice of the present invention, the target 24 is placed on the towing vehicle bed 16 just behind complementary hitching apparatus 22 on an imaginary straight line 36 that extends from the center point 38 of the complementary hitching apparatus 22 rearwardly to intersect the plane of the tailgate 40 at approximately 90 degrees. The driver is able to view through the cab rear window to the target marker 32, against which the driver desires to have the trailer hitch pin 13 make contact to eventually be positioned for engagement with the apparatus 22 and into connection at point 38. To accomplish all of this, the driver moves the vehicle rearwardly toward the trailer visually keeping the hitch pin 13 aligned with the target marker 32. By maintaining the alignment of target marker 32 and hitch pin 13 to vertical centerline contact of hitch pin 13 by target marker 32, the apparatus 12 can be precisely laterally positioned for connection. When the latter occurs, the driver exits the vehicle, removes the target 24 and adjusts the target marker 32 to the top surface 23 of the vehicle hitch apparatus 22, repositions the target 24 to place marker 32 next to trailer hitch apparatus 12 and raises (or lowers) trailer hitch apparatus 12 to position surface 31 to marker 32 height. With surfaces 23 and 31 at the same height, precise vertical alignment of the hitch apparatus 22 and 12 is accomplished. Now, with both lateral and vertical alignment achieved, the driver reenters the vehicle and backs the vehicle to final engagement for connection of the vehicle and trailer hitch apparatus, all without having to make any last moment adjustments.

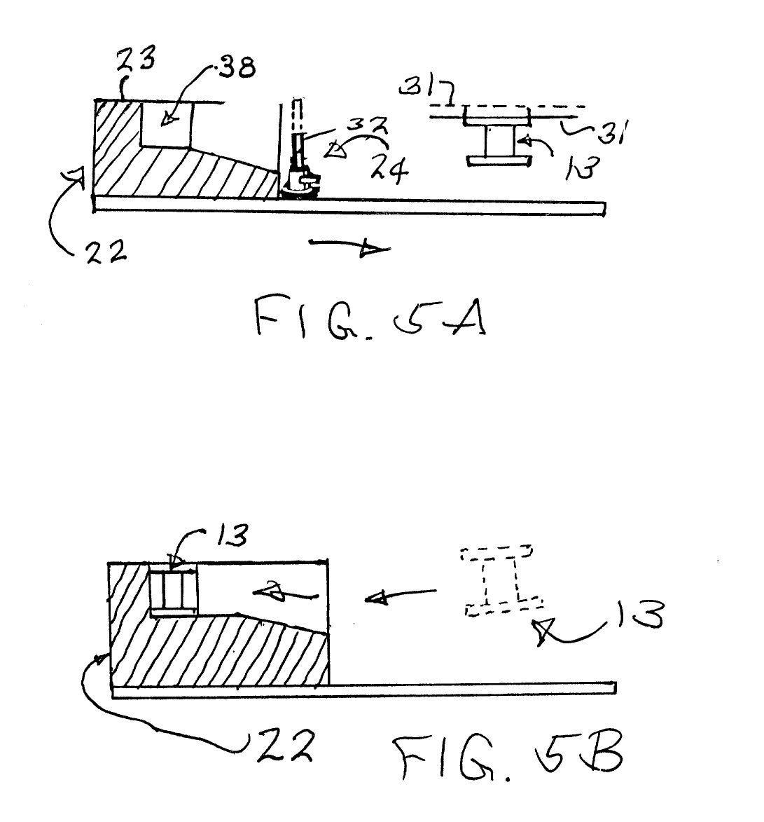

For the following more detailed description of the method of the invention briefly set forth in the preceding paragraph, reference is made to FIGS. 5A and B. Initially, the driver positions the target 24 along the truck bed centerline (e.g., line 36), behind and closely adjacent if not contacting the apparatus 22 (FIG. 5A). The visible marker 32 is extended vertically a sufficient amount so as to be readily visible by the driver looking through the rear window. Now, the driver backs the truck toward the trailer until the target is laterally centered on the hitch pin 13 thereby bringing the truck and trailer into lateral alignment for connection which is a primary object of the invention.

Next, the driver leaves the truck cab and adjusts the top of the visible marker 32 to coincide with the top surface 23 of the apparatus 22. Then, the target is positioned along the truck bed adjacent to the trailer hitch surface 31 (dash line depicts position of the top of the visible marker 32). Finally, the driver raises (or lowers) the trailer surface 31 to coincide with the top of the visible marker 32 and thus with the top surface 23 of the apparatus 22.

Now, the trailer hitch pin 13 is both laterally aligned and vertically positioned so that the driver on reentering the cab can merely back the truck to connect the hitch pin 13 with the apparatus 22 as shown in FIG. 5B. That is, the hitch pin 13 is positioned by the truck backing action into the center point 38. Typical fifth-wheel interconnection apparatus includes means (not shown) mounted within apparatus 22 at the center point 38 which lockingly engages the hitch pin 13 (and thus the trailer) to apparatus 22 aboard the towing vehicle. The trailer hitch is then moved downwardly for final full-load interconnection.

In the practice of the described invention, one individual can with improved efficiency and good prospects of success connect a fifth-wheel trailer hitch to complementary apparatus aboard a towing vehicle with minimal backing operation of the vehicle, and all accomplished without the need of another individual advising and counseling from outside the vehicle.

Although contact between the marker 32 and hitch pin 13 is preferred in most cases, it is to be understood that because of obstructions located in the truck bed (e.g., a tool box) or otherwise, it may be more convenient for the driver to use the lateral centerline of the trailer apparatus 12 in place and instead of the hitch pin 13 centerline as a contact reference for marker 32. In this case, vision is improved by marking the centerline of apparatus 12 distinctively, as with white, yellow or luminescent paint, for example.

Although the invention has been described in connection with a preferred embodiment, it is to be understood that one skilled in the appertaining art may suggest modifications that come within the scope of the invention as described and within the ambit of the appended claims.

What is claimed is:

1. An improved method of power-moving a towing vehicle in a precise rearward direction toward a trailer hitch apparatus movable primarily merely vertically for interconnecting with complementary apparatus aboard the vehicle, comprising:
placing a readily visible target on a generally horizontal surface of the vehicle visible by a vehicle driver from within the vehicle simultaneously with the trailer hitch apparatus, said target being located along an imaginary line in a plane including the vehicle longitudinal axis and closely adjacent the rear of the complementary apparatus;
guide sighting along the imaginary line by a vehicle driver as the vehicle is power moved toward the trailer until the trailer hitch is positioned directly behind the complementary apparatus and in close proximity to the target

2. A method as in claim 1, including the further step of removing the target after the trailer hitch is positioned directly behind the complementary apparatus before final interconnection of the trailer hitch and the complementary apparatus;
adjusting the target height to the same height as the complementary apparatus;
placing the target closely adjacent to the trailer hitch apparatus; and
moving the trailer vertically to position the trailer hitch apparatus to the target height.

3. A method as in claim 1, including the further step of maintaining the trailer hitch, complementary apparatus and target in substantially the same plane while the vehicle is moved rearwardly.

4. A method as in claim 1, including the further step of removing the target after the trailer hitch is positioned directly behind and in close proximity to the complementary apparatus and before final interconnection of the trailer hitch and complementary apparatus.

5. A method as in claim 1, including the further step of removably securing the target to the vehicle horizontal surface by a magnetic force.

6. A method as in claim 1, including the further step of treating the target surface to enhance visibility.

7. An improved method of interconnecting trailer hitch apparatus of the fifth wheel category having a hitch pin and further provided complementary apparatus mounted aboard the open bed of a towing vehicle, comprising the steps of:
placing a readily visible target of selectively adjustable height extension immediately adjacent and behind the complementary apparatus on an imaginary longitudinal axis of the vehicle;
driver controlled backing of the vehicle toward the trailer while the driver keeps the hitch pin laterally aligned with the target until the trailer hitch pin is closely adjacent the target;
adjusting the target height extension to a predetermined amount for enabling ready engagement of the hitch pin with the complementary apparatus;
adjusting the vertical height of the hitch pin to correspond to that of adjusted target height extension; and
driver backing the vehicle in a single movement to interconnect the hitch pin with the complementary apparatus.

8. A target for removable positioning on a vehicle horizontal surface located for ready viewing by a vehicle driver through a vehicle rear window, comprising:
a platelike base;
a support housing affixed to the base including an opening in a top surface;
a visible marker slidingly received within the support housing opening and adjustably extendible over a predetermined range from said housing opening; and
means mounted to the support housing for selectively securing the marker over a range of extensions from the support housing.

9. A target as in claim 8, in which the base is magnetized.

10. A target as in claim 8, in which the base has a flat lower surface that is arranged at about 90 degrees to the direction of extension of the marker from the support housing.

11. A target as in claim 8, in which the marker outer surface is modified to enhance visibility.
